(19) United States
(12) Patent Application Publication
(10) Pub. No.: US 2009/0058769 A1
(43) Pub. Date: Mar. 5, 2009

(54) ACTIVE MATRIX DISPLAY DEVICE

(76) Inventor: Kazuyoshi Kawabe, Yokohama (JP)

Correspondence Address: J. Lanny Tucker;Patent Legal Staff, Eastman Kodak Company, 343 State Street, Rochester, NY, 14650-2201, US

(21) Appl. No.: 12/191,546

(22) Filed: Aug. 14, 2008

(30) Foreign Application Priority Data
Aug. 29, 2007 (JP) 2007-222153

(51) Int. Cl. G09G 3/30

(52) U.S. Cl. 345/76

(57) ABSTRACT

An active matrix display device, wherein a unit pixel comprising a plurality of sub-pixels is correlated to video data having bits corresponding to a plurality of gray scale levels for a pixel, one bit of the video data is correlated to at least one frame display sub-pixel in the unit pixel, directly written onto the frame display sub-pixel, and displayed for one frame period, and the remaining plurality of bits of the video data are temporarily stored in a frame memory, separated into sub frames and written onto at least one other sub-frame display sub-pixel of the unit pixel, and displayed separately for sub-frame periods.

### CROSS-REFERENCE TO RELATED APPLICATION

This application claims priority of Japanese Patent Application No. 2007-222153 filed Aug. 29, 2007 which is incorporated herein by reference in its entirety.

### FIELD OF THE INVENTION

The present invention relates to an active matrix display device using display elements such as organic EL (Electroluminescence) elements.

### BACKGROUND OF THE INVENTION

Display panels in which organic EL elements are employed as light-emitting elements are conventionally known, and have become widely available as thin display devices. Although passive and active organic EL display devices are available, active matrix display devices, in which display is controlled by a thin film transistor provided in each pixel, can achieve a higher definition display, and are becoming more popular.

Organic EL elements are current-driven elements in which each pixel is provided with a drive transistor for controlling an amount of current based on a data voltage in order to control the emission amount of the elements based on analog signal data. However, consistently providing at all times an appropriate current according to a data voltage by reducing the non-uniformity of characteristics of the driving transistor has been difficult to achieve.

Consequently, a method has been suggested for digitally driving an active matrix organic EL panel (refer to WO 2005/116971). In that method, the emission amount (amount of light emitted) of each pixel can be made constant by employing digital driving, and the influence of the non-uniformity of characteristics of the driving transistors can thereby be reduced.

Digital driving, or “digital drive”, as disclosed in that conventional reference is a drive method for varying the emission period of each pixel in order to achieve multiple gray scales (gray scale levels), and this method can be realized by dividing a single frame video image (hereinafter “one-frame video image”) into sub frames.

### SUMMARY OF THE INVENTION

A frame memory for storing at least one frame of input data is required in order to divide the one-frame video image into sub frames. However, as the cost of introducing additional frame memories for storing one-frame data can be expensive, there has been a high demand that the required capacity of frame memories be reduced as much as possible.

In one aspect of the present invention, there is provided an active matrix display device wherein a unit pixel including a plurality of sub-pixels is correlated to video data of a plurality of gray scales for a pixel; one bit of the video data is correlated to at least one frame display sub-pixel in the unit pixel, directly written onto the frame display sub-pixel, and displayed for one frame period; and the remaining plurality of bits of the video data are temporarily stored in a frame memory, separated into sub frames and written onto at least one other sub-frame display sub-pixel of the unit pixel, and displayed separately for sub-frame periods.

Preferably, in the active matrix display device, an upper bit of the video data is correlated to the frame display sub-pixel, and a lower bit of the video data is correlated to the sub-frame display sub-pixel.

Also, the active matrix display device preferably includes a register for storing one horizontal period of data of the video data, wherein when the one horizontal period of data is stored in the register, the lower bit data is written onto the frame memory, and the upper bit data is written onto the corresponding frame display sub-pixel.

In addition, preferably, in the active matrix display device, during each horizontal period, the lower bit data stored in the frame memory is written onto sub-frame display sub-pixels for a plurality of lines, and the upper bit stored in the register is written onto the frame display sub-pixel.

Further, in the active matrix display device, the write timing for the sub-frame display sub-pixel is preferably arranged to be earlier than the write timing for the frame display sub-pixel.

Preferably, the active matrix display device further includes a register for storing one horizontal period of data of the video data, wherein, when the one horizontal period of data is stored in the register, data except for that for a most significant bit in the lower bit is written onto the frame memory, and data of the most significant bit in the lower bit is written onto the sub-frame display sub-pixel.

Moreover, in the active matrix display device, for data of the lower bit, one set of data (one data item) is selected from a plurality of sets of video data corresponding to adjacent unit pixels, and data of a plurality of bits of the unit pixel corresponding to the selected data is displayed using sub-frame display sub-pixels in the adjacent unit pixels.

In another aspect of the present invention, there is provided an active matrix display device wherein a unit pixel including a plurality of sub-pixels is correlated to video data of a plurality of gray scales for a pixel, one bit of the video data is correlated to at least one frame display sub-pixel in the unit pixel, directly written onto the frame display sub-pixel, and displayed for one frame period, and, for lower bit data, one set of data is selected from a plurality of sets of video data corresponding to adjacent unit pixels, and data of a plurality of bits of the unit pixel corresponding to the selected data is displayed using sub-frame display sub-pixels in the adjacent unit pixels.

With the present invention, because corresponding bits of a video image can be directly written onto sections of a unit pixel formed by a plurality of sub-pixels, it is not necessary to store the bits in a frame memory.

### BRIEF DESCRIPTION OF THE DRAWINGS

The accompanying drawings, which are incorporated in and constitute a part of the specification, illustrate an embodiment of the invention and, together with the description, serve to explain the principles of the invention, in which:

FIG. 1A is a diagram showing a dynamic memory pixel circuit;

FIG. 1B is a diagram showing a static memory pixel circuit;

FIG. 2 is a diagram showing a unit pixel circuit;

FIG. 3 is a timing chart for sub frames;

FIG. 4A is a timing chart for selectively controlling data writing during a horizontal period;

FIG. 4B is a timing chart for selectively controlling data writing during another horizontal period;

FIG. 5 is a diagram showing the internal structure of a gate driver;

FIG. 6 is a diagram showing the structure of a display system;

FIG. 7 is a timing chart for selectively controlling data writing during another horizontal period;

FIG. 8 is a diagram showing the internal structure of another gate driver;

FIG. 9 is a timing chart for selectively controlling data writing during another horizontal period;

FIG. 10 is a diagram showing an example of a pattern of adjacent pixels for multiple gray scales; and

FIG. 11 is a diagram showing another example of a pattern of adjacent pixels for multiple gray scales.

### DETAILED DESCRIPTION OF THE INVENTION

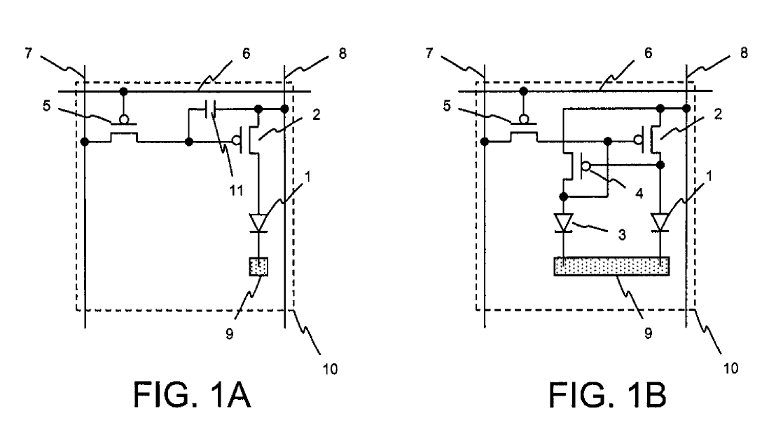

FIGS. 1A and 1B show equivalent circuits of two types of active matrix organic EL pixels 10. The pixel circuit shown in FIG. 1A is a dynamic circuit including a (first) drive transistor 2, an (a first) organic EL element 1, a gate transistor 5, and a storage capacitor 11 as means for holding data. The source terminal of the drive transistor 2 is connected to a power supply line 8 shared with all pixels, the drain terminal thereof is connected to the anode of the organic EL element 1, and the gate terminal thereof is connected to one end of the storage capacitor 11 and the source terminal of the gate transistor 5. The other end of the storage capacitor 11 is connected to the power supply line 8, the gate terminal of the gate transistor 5 is connected to a gate line 6, and the drain terminal thereof is connected to a data line 7. In addition, the cathode of the organic EL element 1 is connected to a cathode electrode 9 shared with all pixels.

When the gate line 6 is selected (a Low level signal is applied) and High or Low digital data is sent to the data line 7, the digital data is written in the storage capacitor 11, and the organic EL element 1 of each pixel is illuminated or extinguished according to the data. As such, gate lines 6 are successively selected and the same processes are performed in pixels on each row to display video images.

Here, as the storage capacitor 11 of the pixel shown in FIG. 1A cannot hold data for a long period of time, data must be periodically written and refreshed in the capacitor. However, when this pixel is employed, as the number of transistors can be reduced, advantages can be obtained such that an aperture ratio can be maximized and high definition display can be easily achieved.

On the other hand, the pixel circuit shown in FIG. 1B does not include a storage capacitor 11, but does include a second drive transistor 4 and a second organic EL element 3. Further, in this pixel circuit, first and second organic EL elements 1, 3 and first and second drive transistors 2, 4 constitute a static memory. That is, the gate terminal of the second drive transistor 4 is connected to the connection point of the anode of the first organic EL element 1 and the drain terminal of the first drive transistor 2, the source terminal thereof is connected to a power supply line 8, and the drain terminal thereof is connected to the anode of the second organic EL element 3. Further, the cathode of the second organic EL element 3 is connected to a cathode electrode 9 shared with the first organic EL element 1, and the gate terminal of the first drive transistor 2 and the source terminal of a gate transistor 5 are connected to the connection point between the drain terminal of the second drive transistor 4 and the anode of the second organic EL element 3.

In the pixel shown in FIG. 1B, when the gate line 6 is selected (a Low level signal is applied) and High or Low digital data is provided to the data line 7, the drive transistor 2 is turned on or off such that the second drive transistor 4 complementarily cooperates with the first drive transistor 2 to perform static memory operation. That is, when a Low level signal is applied to the gate terminal of the first drive transistor 2, the first drive transistor 2 is turned on, the first organic EL element 1 is illuminated, a High level signal is applied to the gate terminal of the second drive transistor 4, and the second drive transistor 4 is turned off. The voltage of the anode of the second organic EL element 3 connected to the gate terminal of the first drive transistor 2 is reduced to a voltage near that of the cathode because the second drive transistor 4 is turned off, and remains at the written Low level even after the gate transistor 5 is turned off. Similarly, when the High value is written onto the first drive transistor 2, the first drive transistor 2 is turned off, the second drive transistor 4 is turned on, and the gate terminal of the first transistor 2 remains at the written High level even after the gate transistor 5 is turned off. As above, because the static memory shown in FIG. 1B holds data which has been written even if refresh operation is not executed, the power consumption for the refresh operation can be reduced. However, when the pixel shown in FIG. 1B is employed, as the number of transistors increases in comparison to the pixel shown in FIG. 1A, the area of a pixel becomes large, making it difficult to achieve a high definition display.

As the pixels shown in FIGS. 1A and 1B each have inherent advantages and disadvantages, it is desirable that an appropriate pixel be selected according to the intended application.

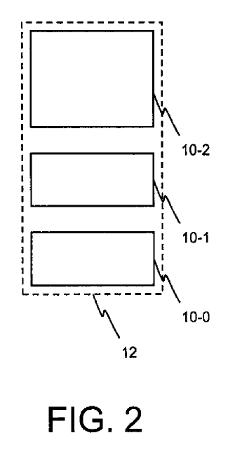

FIG. 2 shows an example of a unit pixel 12 in which three pixels 10 as shown in FIGS. 1A or 1B with different emission intensities are provided as sub-pixels. The ratio of the emission intensities depends on the number of gray scales. For example, in case of six bits, the area ratio of each pixel is 10-2:10-1:10-0=32:16:15. If the unit pixel 12, into which the three pixels with different emission intensities are provided as sub-pixels, is used as shown in FIG. 2, the upper two or three bits of the six bits can be directly written onto the pixels 10-2, 10-1, and 10-0, and the capacity of a frame memory are required only for storing the remaining bits. Therefore, the number of bits required to store one frame of input data in the frame memory can be reduced. Also, the displayed pixel 10-0 reflects the bit data of the remaining three or four bits stored in the frame memory because of the use of the sub frames into which a frame is divided.

The greater the number of pixels 10 with different emission intensities provided, the greater will be the number of pixels onto which digital data can be directly written. Therefore, the number of bits required for the frame memory can be further reduced. In general, however, it is difficult to increase the number of pixels of this type with different emission intensities in high definition display applications. For example, for a bottom-emission 2.5 inch QVGA (240 RGB×320) display, in which light is emitted from a transistor substrate side, the maximum number of such pixels with different emission intensities that can be provided is no more than three, as shown in FIG. 2, given the current technology.

However, if the three pixels 10-2, 10-1, and 10-0 are employed as shown in FIG. 2, at least two bits of a frame memory can be omitted per pixel unit. A method for generating six-bit gray scales using the pixel shown in FIG. 2 will be described in detail below.

Input data is normally sent at a timing such that each line is selected only once for each one-frame period. Because in digital drive using sub frames this timing does not correspond to timing for the sub frames, it is necessary to temporarily store one frame of input data in a frame memory, to read out data divided according to the sub frames at the timing for sub frames, and to write the data with each line selected as many times as the number of sub frames. However, when the unit pixel with three pixels 10-2, 10-1, and 10-0 as shown in FIG. 2 is used as described in the present embodiment, input data can be written onto the pixels 10-2, 10-1, and 10-0 at the timing in which the input data is input.

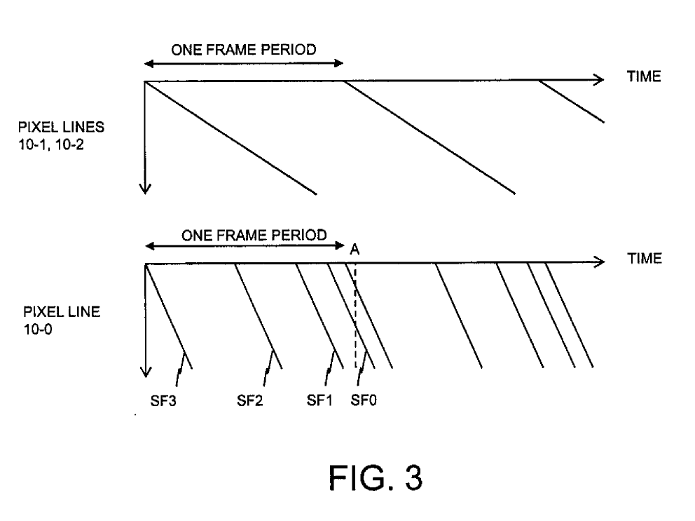

For example, if, as shown in FIG. 3, the upper two bits of six bits are written onto the pixels 10-2 and 10-1, and the data of the remaining four bits is reflected for display using the pixel 10-0 by sub frames, the upper two bits of six-bit input data are written onto the pixels 10-2 and 10-1 at the timing for inputting input data, while the lower four bits thereof are sequentially stored in a frame memory at the input timing of the input data.

In this example, the pixels 10-2 and 10-1 are frame display sub-pixels, and the pixel 10-0 is a sub-frame display sub-pixel.

As shown in FIG. 3, writing onto the pixel 10-0 using the sub frames starts when data is written onto the pixels 10-2 and 10-1. However, because in the pixel 10-0 sub-frame display must start before new input data is input, the four-bit data of the previous frame is used for a part of the lower four bits. That is, in FIG. 3, although the operation of the pixel 10-0 starts when the writing of a sub frame SF3 starts, the data (bit 3 data) of the sub frame SF3 is data input for the previous frame because the display of the sub frame SF3 is read earlier than transfer timing of input data sent for a one-frame period. As the storage of new input data in a frame memory has already begun when the writing of the sub frame SF2 starts, in some lines the bit 2 data is displayed with the new input data. For bit 1 data and bit 0 data, the display of some lines reflects the new data, while the display of some other lines reflects the data for the previous frame.

Although it appears that the mixing of new data and old data will distort a video image, this can be ignored for the following reasons. First, as new input data is always used for the upper two bits, which are dominant in a video image, distortion caused by the lower four bits can be considered minuscule. Second, because, for a moving image, in which video images vary frame by frame, there is a correlation between adjacent frames, the new frame data and the previous frame data have some degree of similarity. In addition, the degree to which users are able to distinguish the differences in the details of the moving image has some effect on reducing the influences caused by a video image distortion. Furthermore, as almost no differences can be found between frames for a static image, a video image distortion can be completely ignored for static images and moving images which are relatively static.

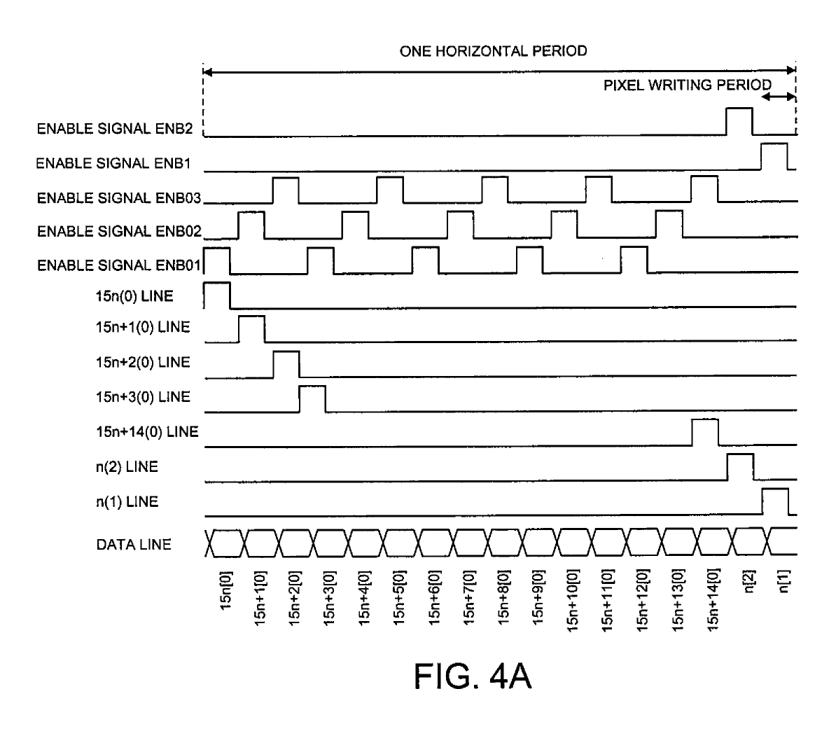

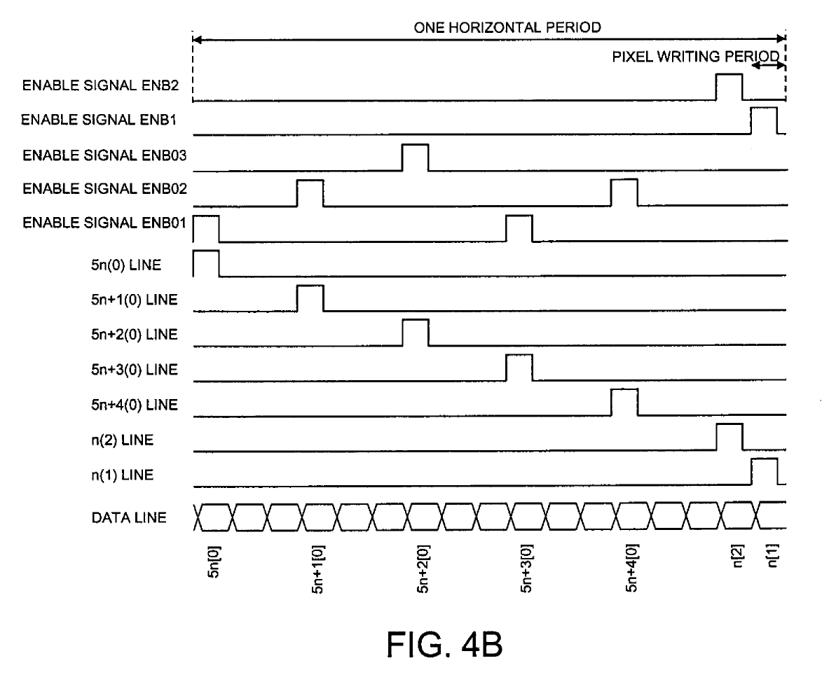

When input data for three pixels in a unit pixel is written with at different timings, it is required necessary to select each line in synchronization with the input of data input and to execute the writing, as shown in FIGS. 4A and 4B, in order to avoid a situation in which a pixel is simultaneously accessed.

FIG. 4A shows an example in which one horizontal period synchronized with data input is divided into seventeen periods, data is consecutively written onto the pixels 10-0 in fifteen lines for the first fifteen periods, and data is written onto the pixels 10-2 and 10-1 for the remaining two periods. As input data is normally transferred dot by dot, the accumulation of one line of input data and conversion of the input data into line data is completed near the end of one horizontal period. Therefore, the timing for writing data onto the pixels 10-1 and 10-2 must be set to a later point. As the time prior to this later point can be used for writing data onto the pixels 10-0, data stored in a frame memory is read out and consecutively written onto a corresponding line during these periods. It is only necessary to store one line of input data in a register when the input data is converted into line data. Also, data provided to the pixels 10-0 is stored in the frame memory so that pixel data for each line can be output from the frame memory.

When data is consecutively written onto the pixels 10-0 on the fifteen lines as described in the present embodiment, data can be written onto all of the lines at fifteen times the speed at which input data is conventionally written. Thus, an emission period corresponding to one fifteenth of a one-frame period, namely a LSB for four-bit input data, can be achieved.

For example, while input dot data for the nth line is being converted into line data, the gate lines from the gate line 15n(0) for the pixel 10-0 on the 15nth (15×n) line through the gate line 15n+14(0) for the pixel on the 15n+14th line are consecutively and sequentially selected. In synchronization with this selection, data for any one sub-frame from 15n[0] to 15n+14[0] for the pixel 10-0 corresponding to a selected line is provided to a data line. Hence, sub-frame data read from the frame memory is written onto the pixels on the consecutive lines from the 15nth line to the 15n+14th line. The upper two-bit data n[2] and n[1] of the nth line data, which is data converted into line data near the end of the one horizontal period, is sequentially provided to the data line, and, when the gate line n(2) for the pixel 10-2 and the gate line n(1) for the pixel 10-1 on the nth line are selected, the input data is written onto the pixels 10-2 and 10-1, respectively. The remaining four-bit data is written onto the frame memory, and then the horizontal period for the nth line terminates. Writing onto the pixels 10-0 completes at timing one fifteenth that of the timing required for the pixels 10-2 and 10-1. Then, the process moves onto the next sub frame, and the subsequent video image is displayed by repeating the same horizontal period.

A method as shown in FIG. 4B can also be used. In this method, different sub-frame data is written onto different lines at one timing, such as the timing A in FIG. 3, but this method differs from the method shown in FIG. 4A in that data is not consecutively written, but reservation periods (two-line period in FIG. 4B) are instead provided between writing periods for consecutive lines, and these reservation periods can be arbitrarily used. For example, at the timing A in FIG. 3, it is necessary that the bit 0 data of the sub frame SF0 and the bit 3 data of the next sub frame SF3, which are for two respective different lines, be selected and written. However, in FIG. 4B, when the bit 0 data of the sub frame is written onto the 5nth line and the bit 3 data of the next sub frame SF3 is written onto another line, the gate line 5n(0) for the pixel 10-0 on the 5nth line is selected and the bit 0 data 5n[0] of the sub frame SF0 is written. Then, during any one of the above-described reservation periods, a line for writing the bit 3 data of the sub frame SF3 is selected and the sub-frame data is provided to a data line so that the bit 3 data of the sub frame SF3 can be written onto the pixel 10-0. As a reservation period for two lines is provided in FIG. 4B, different sub-frame data can be written onto a total of three different lines. That is, three lines can be selected at the timing A in FIG. 3.

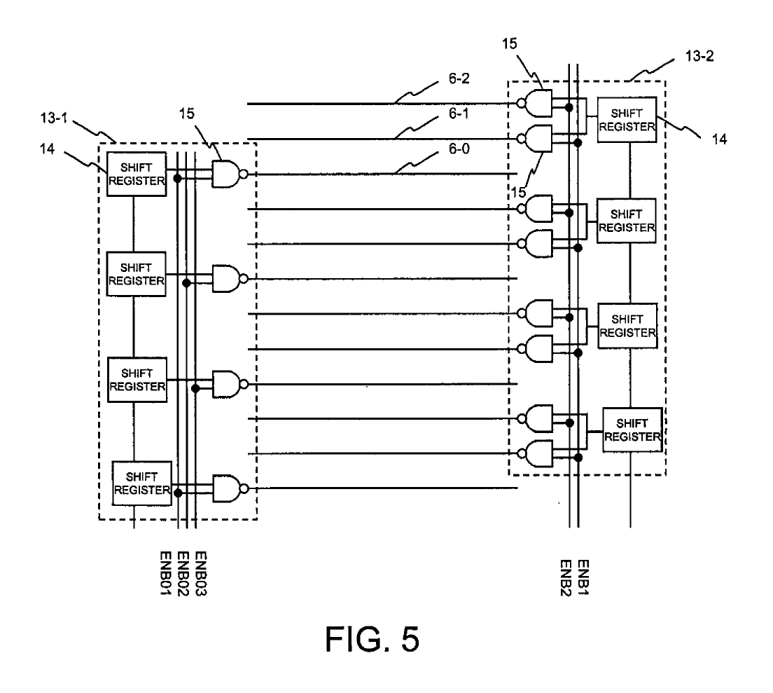

Line selection control as shown in FIGS. 4A and 4B can be easily achieved by adopting a gate driver structure as shown in FIG. 5. FIG. 5 shows an example in which two types of gate drivers, a first gate driver 13-1 and a second gate driver 13-2, are employed and operated at different timings to achieve the line selection control as shown in FIGS. 4A and 4B. Either the gate driver 13-1 or the gate driver 13-2 has a shift register 14 for each unit pixel line. One enable circuit 15 is provided for each unit pixel line (as the unit pixel has three pixels, the unit pixel corresponds to three pixel lines) in the first gate driver 13-1, while two enable circuits are provided for each unit pixel line in the second gate driver 13-2.

The first gate driver 13-1 operates at the timing for controlling a gate line 6-0 for the pixel 10-0, and the second gate driver 13-2 operates at the timing for controlling gate lines 6-2 and 6-1 for the pixels 10-2 and 10-1, respectively. That is, in FIG. 4A, as fifteen lines are consecutively selected in the first half portion of one horizontal period, the first gate driver 13-1 transfers selection data to be stored in the shift register 14 to a subsequent stage, and sequentially selects the gate line 6-0 at a timing fifteen times the speed for the one horizontal period. Meanwhile, the second gate driver 13-2 transfers the selection data to be stored in the shift register 14 to a subsequent stage once in one horizontal period, and selects the gate lines 6-2 and 6-1 using an enable circuit 15 for selecting and enabling each gate line.

The first gate driver 13-1 selects the gate line 6-0 by setting enable signal lines ENB01, ENB02, and ENB03 to High at the timing as shown in FIG. 4A. In the second gate driver 13-2, an enable signal line ENB2 selects the gate line 6-2, and an enable signal line ENB1 selects the gate line 6-1.

Selection control in FIG. 4A does not require as many as three enable signal lines in the gate driver 13-1, but requires only one ENB0, into which the ENB01, ENB02, and ENB03 are consolidated. That is, when three High levels of enable signal lines ENB03, ENB02, and ENB01 are provided from one signal line, a selection signal is output from an enable circuit 15 selected by a shift register 14.

On the other hand, three enable signal lines ENB01, ENB02, and ENB03 are required for selection control as shown in FIG. 4B. One input terminal for an enable circuit 15 of the first gate driver 13-1 is connected to enable signal lines ENB01 to ENB03 for every three lines of a unit pixel. Therefore, even if there are three items of selection data to be stored in a shift register 14, the enable signal lines ENB01 to ENB03 can be used to individually select each selection data when different items of selection data are stored in different locations which are separately controlled by enable signal lines ENB01 to ENB03. With this technical feature, when two lines are selected by means of time division selection for a period in FIG. 3 and the bit 0 data of a sub frame SF0 and the bit 3 data of a sub frame SF3 are written, and selection data is stored in a shift register 14 so that the two lines can be selected by different enable signal lines among ENB01 to ENB03, a pixel 10-0 on the 5nth line, for example, can be selected by the enable signal line ENB01 to write the SF0 data, and another line can be selected by ENB02 or ENB03 to write the SF3 data during one of the remaining two reservation periods. On the next 5n+1th line, the enable signal line is used to write the SF0 data, and the SF3 data is written onto another line during one of the remaining two reservation periods. Selection control as shown in FIG. 4B can be achieved by repeating the above process.

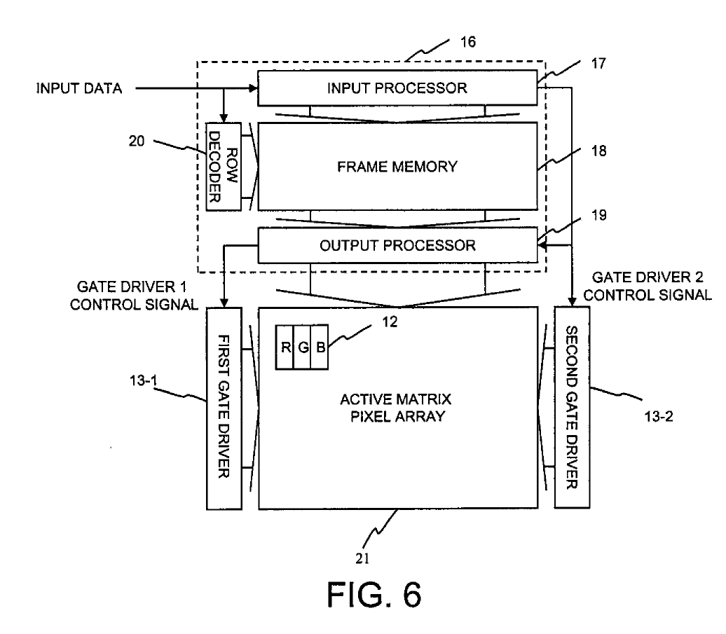

FIG. 6 shows an example of a display system in which a plurality of pixels as shown in FIG. 2 are incorporated into a unit pixel, and which is digitally driven using selection control as shown in FIGS. 4A and 4B. The externally input data can be in the format of, for example, six bits for each color of RGB, wherein each set of six-bit data is input dot by dot to an input processor 17 of a data driver 16. The input processor 17 accumulates one line of input data and converts the data into line data. The upper two bits are directly transferred to an output processor 19, output to an active matrix pixel array 21 in which each unit pixel 12 of RGB is provided in a matrix, and then written onto pixels 10-2 and 10-1 at the timing as shown in FIGS. 4A and 4B. Meanwhile, an appropriate line in a frame memory 18 having a memory capacity of four bits corresponding to each unit pixel 12 is selected by a row decoder, and the lower four bits are written. Appropriate bit data is read from the frame memory 18 at a timing for each sub frame, and the lower four-bit data is written onto a pixel 10-0 at a timing earlier than the timing for writing onto the pixels 10-2 and 10-1. The operation of the second gate driver 13-2 for generating a selection signal for writing the upper two-bit data and the first gate driver 13-1 for generating a selection signal for writing the lower four-bit data at the same timing as sub frame is shown in FIGS. 4A and 4B. The data driver 16 provides control signals to two types of gate drivers 13 to be controlled so as to achieve the operations as shown in FIGS. 4A and 4B, and at the same time provides data corresponding to data lines in the active matrix pixel array 21.

The gate driver 13 can be formed on the same substrate as the unit pixel 12 from a high performance transistor material such as low-temperature polysilicon. Although the data driver 16 can also be formed on the same substrate, the data driver 16 can be structured as a driver IC and implemented in the active matrix pixel array 21.

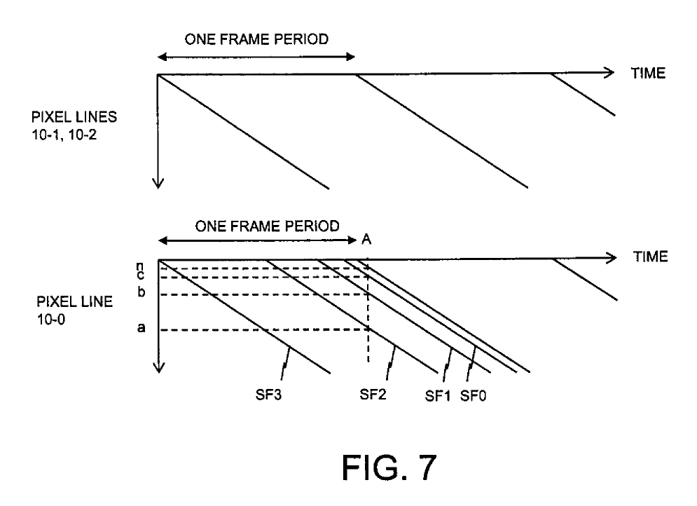

In the above example, pixels 10-2 and 10-1 are allocated to the upper two bits, the capacity of a frame memory for the lower four bits is reduced, and the lower four-bit data of the previous frame is reflected on display in sub frames. However, using the same timing as that at which input data for the selection timing for all gate lines for pixels 10-2, 10-1, and 10-0 as shown in FIG. 7 is performed can enable further reductions in the required one-bit memory capacity, and enable use of new input data for the lower four-bit data reflected on display using sub frames.

As shown in FIG. 7, the upper three bits of input six-bit data are written onto pixels 10-2, 10-1, and 10-0, while the lower three bits thereof are stored in a frame memory 18. While data is being stored in the frame memory 18, the writing of a sub frame SF2 starts, and bit 2 data read from the frame memory 18 is written onto the pixel 10-0 onto which bit 3 data has been written. Here, as the timing for inputting data line by line is the same as the timing for reading sub frames, the sub frames are not read earlier than the timing at which the data is input. Therefore, the bit 2 data read from the frame memory 18 is always new input data. As time advances, when writing a sub frame SF1 starts, new bit 1 data is read and written. Further, the same operation is repeated for a sub frame SF0.

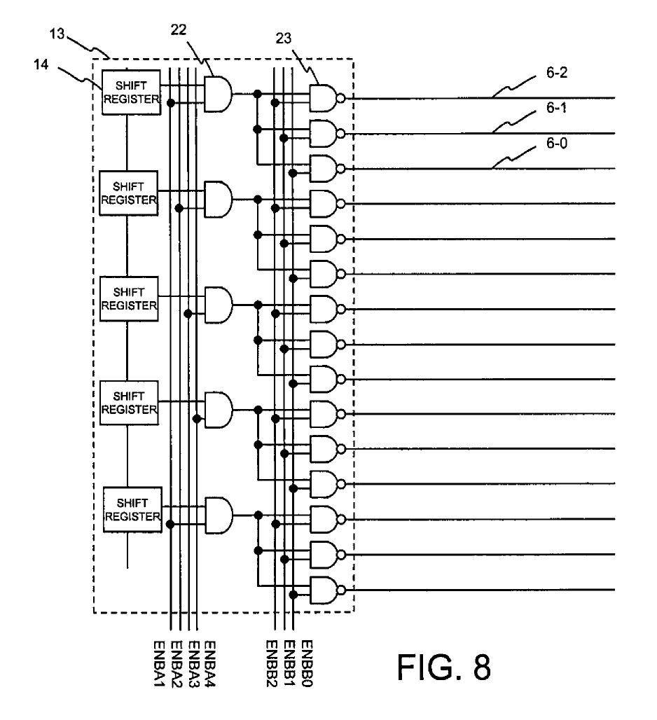

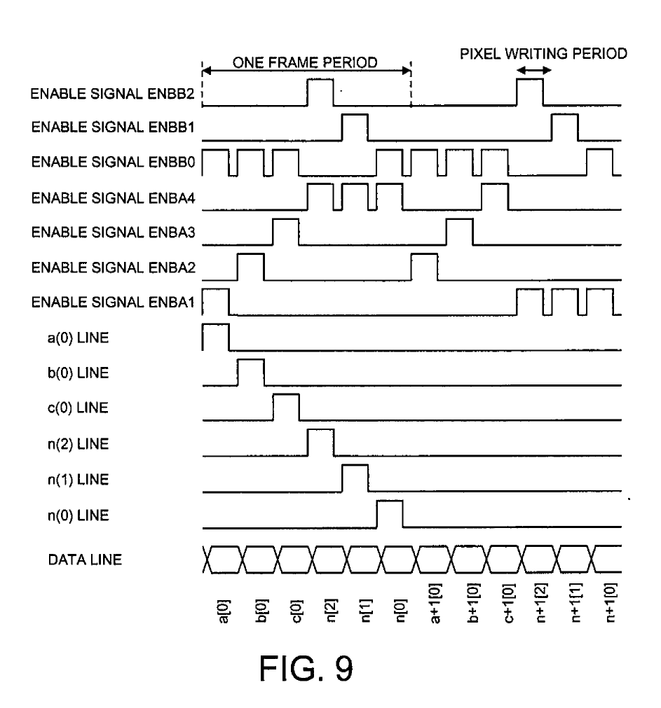

In order to achieve a drive operation as shown in FIG. 7, one type of gate driver 13 as shown in FIG. 8 is used to perform selection control as shown in FIG. 9. The gate driver 13 as shown in FIG. 8 includes a shift register 14, a first enable circuit 22, and a second enable circuit 23. The output of the shift register 14 is input to one input of the first enable circuit 22, and one of ENBA1 to ENBA4 is connected to the other input thereof for every four lines. One input of the second enable circuit 23 is connected to the output of the first enable circuit 22, and the other input thereof is connected to one of ENB0 to ENB2.

Regarding this gate driver 13, the features of a method for driving at timing A in FIG. 7, for example, will be described as follows. At the timing A, writing of a sub frame SF2 starts on the ath line, writing of a sub frame SF1 starts on the bth line, writing of a sub frame SF0 starts on the cth line, and writing of the upper two bit input data and a sub frame SF3 in the next frame starts on the nth line. As shown in FIG. 9, when the input of the first enable circuit 22 on the ath line is connected to the enable signal ENBA1 and selection data is stored in the shift register 14 on the line, the selection data is reflected on the input of the second enable circuit 23 when the enable signal ENBA1 is set to High. At this point, when the enable signal ENBB0 is set to High, the gate line a(0) for the pixel 10-0 on the ath line is selected, and bit 2 data a[0] of the sub frame SF2 on the ath line is written onto the pixel 10-0 on the ath line. Next, when the enable signal ENBA2 is set to High, selection data is stored in the shift register 14 on the bth line, and the enable signal ENBB0 is set to High, the gate line b(0) for the pixel 10-0 on the bth line is selected, and bit 1 data b[0] of the sub frame SF1 on the bth line provided to the data line is written onto the pixel 10-0 on the line. Similarly, for the cth line, when the enable signal ENBA3 is set to High, selection data is stored in the shift register 14 on the line, and ENBB0 is set to High, the gate line c(0) for the pixel 10-0 on the cth line is selected, and bit 0 data c[0] of the sub frame SF0 on the cth line provided to the data line is written onto the pixel 10-0 on the cth line.

After the data which has been transferred dot by dot is converted into line data at the end of one horizontal period for the nth line, while the enable signal ENBA4 is set to High, selection data is stored in the shift register 14 on the nth line, and the enable signal ENBB2 is set to High, the gate line n(2) for the pixel 10-2 on the nth line is selected, and the most significant bit 5 data n[2] of new input data provided to the data line is written onto the pixel 10-2 on the nth line. In addition, when the enable signal ENBB1 is selected, bit 4 data n[1] of the new input data provided to the data line is written onto the pixel 10-1 on the nth line. Further, when the enable signal ENB0 is selected, bit 3 data n[0] of the new input data provided to the data line is written onto the pixel 10-0 on the nth line, and the one horizontal period ends. In order to achieve the control as described above, selection data must be stored in the shift registers 14 on the ath, bth, cth, and nth line, and the ath, bth, cth, and nth lines must be controlled by different respective enable signals ENBA1 to ENBA4.

During the next horizontal period, in the gate driver 13 as shown in FIG. 8, the a+1th line is enabled by the enable signal ENBA2; the b+1th, c+1th, and n+1th lines are enabled by the enable signals ENBA3, ENBA4, and ENBA1, respectively; and the relationships between the enable signals and the lines are sequentially shifted so that the same control as described above can be achieved without any contradictions. That is, a display which always reflects new input data as shown in FIG. 7 can be achieved by using the gate driver 13 as shown in FIG. 8, and repeating the same control as that for the period A at the timing as shown in FIG. 9.

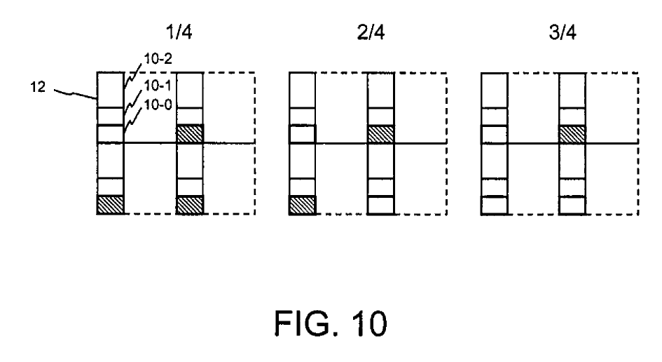

Also, multiple gray scales can be displayed using four vertically and horizontally adjacent pixels 10-0 as shown in FIG. 10 in order to further reduce the required memory capacity of the frame memory 18. The upper two bits of the lower four bits can be generated from the sub frames, and a pseudo gray scale can be generated for the remaining two bits by using a pattern as shown in FIG. 10. Preferably, the pattern as shown in FIG. 10 can be generated for creating four gray scales between consecutive gray scales n and n+1 of the four gray scales generated from the sub frames. For example, regarding a gray scale n+¼, one (blank white) of the four adjacent pixels 10-0 is set as a gray scale n+1, and the remaining three pixels (shaded) are set as a gray scale n so that the average of these gray scales is (3×n+n+1)/4=n+¼ and a gray scale corresponding to the lower two-bit data “01” can be generated. Similarly, for a gray scale n+½ (i.e. n+ 2/4), two of the four adjacent pixels 10-0 are set as a gray scale n, and the remaining two pixels are set as a gray scale n+1 so that the average of these gray scales is (2×n+2n+2)/4=n+½ and a gray scale corresponding to data “10” can be generated, while for a gray scale n+¾, three pixels are set as a gray scale n+1, and the remaining one pixel is set as a gray scale n so that a gray scale corresponding to “11” can be generated.

In case of generating a gray scale using a pattern with adjacent pixels as shown in FIG. 10, as data for only one pixel among four adjacent pixels is reflected in the display, resolution deterioration can appear to be a concern. However, as one pixel 10-0 has only about one-fourth of the total emission intensity, such deterioration is not prominent. Further, changing the location of data for a gray scale n+1 can achieve four patterns, and a different pattern can be used for each frame so that a fixed pattern cannot be distinguished.

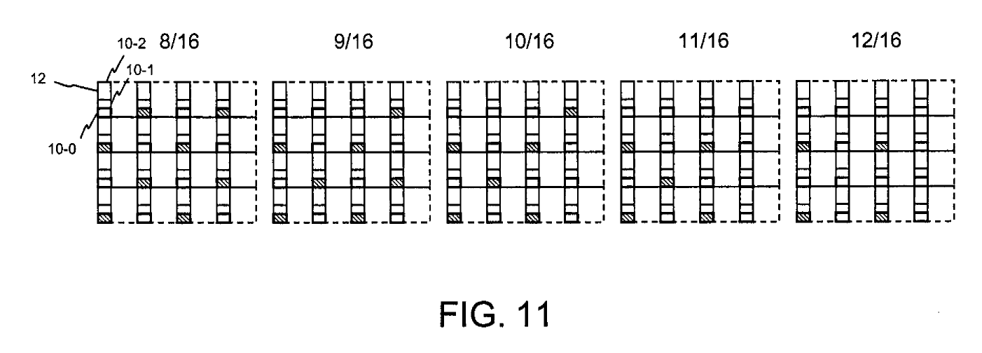

In addition, as shown in FIG. 11, more adjacent pixels can be used to create, for example, a pattern for generating a sixteen level gray scale from adjacent pixels arranged in four rows and four columns, and thereby eliminate all frame memories 18. In such a case, the upper two bits of the lower four bits in the pattern are preferably generated in two rows and two columns as a unit so that a greater resolution can be achieved. The remaining lower two bits are then preferably generated using one of four patterns each of which is arranged in two rows and two columns as a unit. For example, when the pattern 9/16 as shown in FIG. 11 is obtained, one pixel 10-0 which has been turned off (for example, the pixel on the second row and the second column in the pattern on the upper left) is preferably turned on in the four patterns which has been generated in two rows and two columns when the pattern 8/16 is obtained. As the regularity of the remaining three patterns in two rows and two columns can thereby be maintained, resolution deterioration can be reduced. For the pattern 10/16, another pixel 10-0 which has been turned off (for example, the pixel on the second row and the second column in the pattern on the lower right) is preferably turned on, and similarly for the pattern 11/16 another pixel 10-0 is preferably turned on. In the pattern 12/16, the regularity similar to the pattern 8/16 is reproduced so that resolution deterioration can be reduced. Also, a different pattern can be used for each frame so that a fixed pattern cannot be distinguished.

Employing a plurality of pixels in a unit pixel as described above makes it possible to form a pattern with adjacent pixels to facilitate multiple gray scales, and to effectively reduce the capacity required for a frame memory. Although the number of levels of the gray scale can be increased while the required frame memory capacity can be further reduced when more pixels are employed in a unit pixel, the method can be employed to reduce the size of the frame memory even when it is only applied to two pixels. In addition, the pattern with adjacent pixels can be expanded to a pattern such as a pattern arranged in five rows and five columns or an asymmetric pattern arranged in four rows and six columns to increase the number of gray scales. Further, in combination with methods as described above, multiple gray scales for 8 bits, 10 bits, and the like can be achieved.

Furthermore, continuous display using three- or four-bit data stored in the frame memory 18 and a pixel memory, without continuously receiving data from an external source, can be achieved by employing pixels having static memories as shown in FIG. 1B for the upper two bits of a frame display sub-pixel, and employing a pixel as shown in FIG. 1A, which can be structured in a small footprint, for a sub-frame display sub-pixel. Thereby, power consumption for transferring data input externally can be reduced, and lower power consumption can be achieved while more sub-pixels are employed.

The invention has been described in detail with particular reference to certain preferred embodiments thereof, but it will be understood that variations and modifications can be effected within the spirit and scope of the invention.

### PARTS LIST

1 organic EL element
2 drive transistor
3 organic EL element
4 second drive transistor
5 gate transistor
6 gate line
7 data line
8 power supply line
9 cathode electrode
10 organic EL pixels
11 storage capacitor
12 unit pixel
13 first gate driver
14 shift register
15 enable circuit
16 data driver
17 input processor
18 frame memory
19 output processor
21 active matrix pixel array
22 first enable circuit
23 second enable circuit

1. An active matrix display device, wherein
a unit pixel comprising a plurality of sub-pixels is correlated to video data having bits corresponding to a plurality of gray scale levels for a pixel,
one bit of the video data is correlated to at least one frame display sub-pixel in the unit pixel, directly written onto the frame display sub-pixel, and displayed for one frame period, and
the remaining plurality of bits of the video data are temporarily stored in a frame memory, separated into sub frames and written onto at least one other sub-frame display sub-pixel of the unit pixel, and displayed separately for sub-frame periods.

2. The active matrix display device according to claim 1, wherein
an upper bit of the video data is correlated to the frame display sub-pixel, and a lower bit of the video data is correlated to the sub-frame display sub-pixel.

3. The active matrix display device according to claim 2, comprising:
a register for storing one horizontal period of data of the video data, wherein
when the one horizontal period of data is stored in the register, the lower bit data is written onto the frame memory, and the upper bit data is written onto the corresponding frame display sub-pixel.

4. The active matrix display device according to claim 3, wherein
during each horizontal period, first the lower bit data stored in the frame memory is written onto sub-frame display sub-pixels for a plurality of lines, and next the upper bit data stored in the register is written onto the frame display sub-pixel.

5. The active matrix display device according to claim 4, wherein
a write timing for the sub-frame display sub-pixel is set to a timing earlier than a write timing for the frame display sub-pixel.

6. The active matrix display device according to claim 2, comprising:
a register for storing one horizontal period of data of the video data, wherein
when the one horizontal period of data is stored in the register, data other than that for a most significant bit in the lower bit is written onto the frame memory, and the data for the most significant bit in the lower bit is written onto the sub-frame display sub-pixel.

7. The active matrix display device according to claim 2, wherein
for the lower bit data, one set of data is selected from a plurality of sets of video data corresponding to adjacent unit pixels, and data of a plurality of bits of the unit pixel corresponding to the selected data is displayed using sub-frame display sub-pixels in the adjacent unit pixels.

8. An active matrix display device, wherein
a unit pixel comprising a plurality of sub-pixels is correlated to video data of a plurality of gray scale levels for a pixel,
one bit of the video data is correlated to at least one frame display sub-pixel in the unit pixel, directly written onto the frame display sub-pixel, and displayed for one frame period, and
for lower bit data, one set of data is selected from a plurality of sets of video data corresponding to adjacent unit pixels, and data of a plurality of bits of the unit pixel corresponding to the selected data is displayed using sub-frame display sub-pixels in the adjacent unit pixels.
